(19) United States
(12) Patent Application Publication
(10) Pub. No.: US 2013/0089028 A1
(43) Pub. Date: Apr. 11, 2013

(54) WIRELESS COMMUNICATION SYSTEM AND METHOD USING DIRECTIONAL COMMUNICATION

(71) Applicant: Electronics Telecommunications Research Institut, Daejeon (KR)

(72) Inventors: Jae Ho Lee, Daejeon (KR); Hyung-seok Lee, Daejeon (KR); Seok Jin Yoon, Daejeon (KR); Min Hong Yun, Daejeon (KR); Cheol Ryu, Daejeon (KR); Do Hyung Kim, Daejeon (KR); Jin-Suk Ma, Daejeon (KR)

(73) Assignee: Electronics Telecommunications Research Institute, Daejeon (KR)

(21) Appl. No.: 13/633,389

(22) Filed: Oct. 2, 2012

(30) Foreign Application Priority Data
Oct. 7, 2011 (KR) 10-2011-0102602

(51) Int. Cl. H04W 76/02

(52) U.S. Cl. 370/328

(57) ABSTRACT

A wireless communication system and a wireless communication method using directional communication are provided. The wireless communication method includes a communication request device transmitting a communication request message to a communication target device using directional communication, the communication request device receiving a response message that includes wireless communication connection information of the communication target device generated in response to the communication request message from the communication target device, the communication request device determining a wireless communication technology based on the wireless communication connection information, and the communication request device performing wireless connection with the communication target device according to the determined wireless communication technology.

### CROSS-REFERENCES TO RELATED APPLICATIONS

The present application claims priority under 35 U.S.C 119(a) to Korean Application No. 10-2011-0102602, filed on Oct. 7, 2011, in the Korean Intellectual Property Office, which is incorporated herein by reference in its entirety set forth in full.

### BACKGROUND

Exemplary embodiments of the present invention relate to a wireless communication system and a wireless communication method using directional communication, and more particularly, to a wireless communication system and a wireless communication method using directional communication, which can easily acquire wireless communication connection information, such as a communication identifier of a communication target device and wireless communication technologies that the communication target device supports using the directional communication.

Recently, as the use of smart phones increases rapidly, the dependence on a mobile communication system of a mobile service has increased, and primary factors, such as central concentration of data traffic and increase of a burden of data communication rental fees, become obstacles to activate the mobile service.

In order to overcome the above-described problems, the mobile service decentralizes data through local wireless communication networks, such as Wi-Fi, Wi-Fi P2P, Bluetooth, and Zigbee.

In particular, since the Wi-Fi P2P technology does not require additional communication infra and can support communications between mobile devices through software upgrade only without changing the existing Wi-Fi hardware, the use of the Wi-Fi P2P technology has increased rapidly in mobile devices and home electronic devices.

FIG. 1 is a diagram illustrating a process in which a mobile device in the related art selects a communication target device in a list of searched surrounding devices.

In general, a process in which a mobile device selects a communication target device and performs wireless communication with the selected device includes a step of acquiring information on a communication identifier of the communication target device and wireless communication technologies supported by the communication target device and a step of performing the wireless communication based on the acquired information.

In the related art, as shown in FIG. 1, a user can search for surrounding access pointers (APs) and surrounding devices through a mobile device and acquire information on the communication identifier of the communication target device through a list of searched access pointers and surrounding devices.

Thereafter, the user can select the communication target device to be connected in consideration of the reception intensity of radio waves and services provided by the corresponding devices in the searched list, and perform wireless communication with the selected communication target device.

However, according to the above-described method, if a user attempts to connect to a surrounding device in a state where various devices are densely provided, it is difficult for the user to select the communication target device to be actually connected among a large number of communication identifiers in the searched list.

Further, when a user performs connection to a surrounding device in a new environment, the user is usually unaware of the communication identifier of the communication target device in advance.

That is, according to the method in the related art, it is troublesome and difficult for the user to acquire the communication identifier of the communication target device and information for other connections.

### SUMMARY

An embodiment of the present invention relates to a wireless communication system and a wireless communication method using directional communication, which can easily acquire wireless communication connection information, such as a communication identifier of a communication target device and wireless communication technologies that the communication target device supports using the directional communication.

In one embodiment, a wireless communication system using directional communication includes: a communication request device determining a wireless communication technology based on wireless communication connection information acquired through a directional communication medium and performing wireless communication connection; and a communication target device providing the wireless communication connection information to the communication request device through the directional communication medium.

The wireless communication connection information may include at least one of a communication identifier of the communication target device, wireless communication technologies that are supported by the communication target device, and service information that is provided by the communication target device.

The communication request device may include a directional communication unit transmitting a communication request message to the communication target device through the directional communication medium and receiving the wireless communication connection information from the communication target device through the directional communication medium; a communication method determination unit determining the wireless communication technology based on the wireless communication connection information; and a control unit controlling a wireless communication unit according to the determined wireless communication technology and performing the wireless communication connection with the communication target device.

The communication method determination unit may determine the wireless communication technology according to a predefined rule through comparison of the wireless communication technologies that are provided by the communication request device with the wireless communication technologies that are supported by the communication target device.

The communication method determination unit may determine the wireless communication technology according to an input from a user.

The communication target device may include a device information management unit storing the wireless communication connection information; and a directional communication unit receiving the communication request message from the communication request device through the directional communication medium and transmitting the wireless communication connection information to the communication request device through the directional communication medium.

The directional communication medium may be directional beams or directional radio waves.

In another embodiment, a wireless communication method using directional communication includes acquiring, by the communication request device, wireless communication connection information of a communication target device through a directional communication medium; determining, by the communication request device, a wireless communication technology based on the wireless communication connection information; and performing, by the communication request device, wireless communication connection with the communication target device according to the determined wireless communication technology.

The wireless communication connection information may include at least one of a communication identifier of the communication target device, a wireless communication technologies that are supported by the communication target device, and service information that is provided by the communication target device.

The step of acquiring the wireless communication connection information may include transmitting, by the communication request device, a communication request message to the communication target device through the directional communication medium; and receiving, by the communication request device, a response message which includes the wireless communication connection information of the communication target device that is generated in response to the communication request message from the communication target device through the directional communication medium.

The wireless communication method using directional communication according to another embodiment may further include extracting, by the communication target device, the wireless communication connection information of the communication target device if the communication request message is received; and transmitting, by the communication target device, the response message that includes the wireless communication connection information to the communication request device through the directional communication medium.

In the step of determining the wireless communication technology, the communication request device may determine the wireless communication technology according to a predefined rule through comparison of the wireless communication technologies that are provided by the communication request device with the wireless communication technologies that are supported by the communication target device.

In the step of determining the wireless communication technology, the wireless communication technology may be determined according to a determination input from a user.

The directional communication medium may be directional light beams or directional radio waves.

According to the present invention, a user can easily connect to a desired communication target device by pointing at the communication target device as using a remote controller.

That is, the user can easily acquire the wireless communication connection information of the communication target device even in an environment where a large number of devices coexist by the operation of emitting directional beams or directional radio waves to the communication target device through adjustment of the angle and the direction of the directional communication unit 110.

Further, according to the present invention, since the information on the communication identifier of the communication target device to be connected is easily acquired, the wireless connection with the corresponding communication target device can be easily performed.

Further, according to the present invention, since the communication target device can be selected using the directional communication, the search range can be reduced in comparison to a case where the surrounding devices are searched for in an omnidirectional range of 360 degrees from the viewpoint of device filtering.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a process in which a mobile device in the related art selects a communication target device in a list of searched surrounding devices;

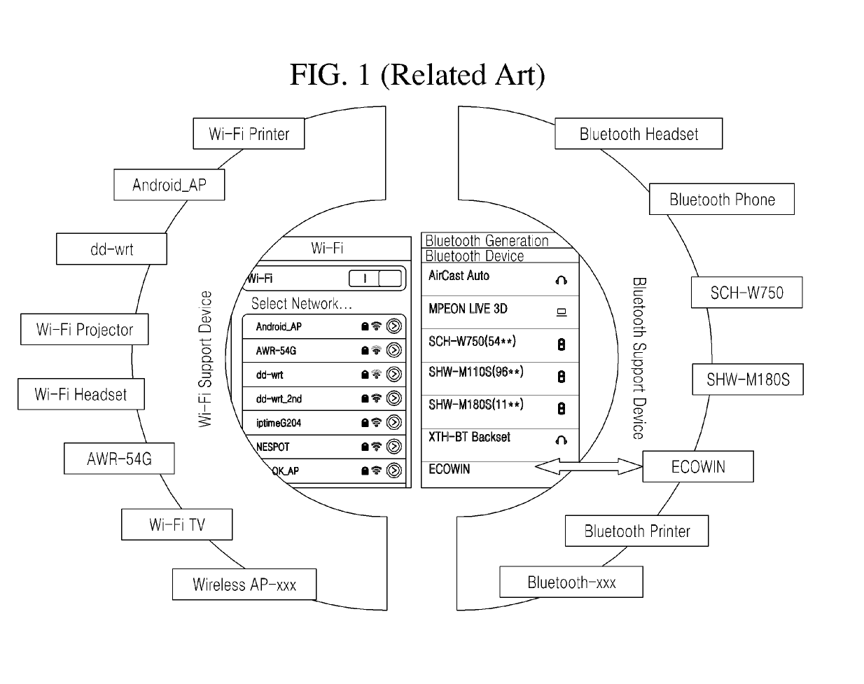

FIG. 2 illustrates a block diagram of a wireless communication system using directional communication according to an embodiment of the present invention; and

FIG. 3 illustrates a flowchart of a wireless communication method using directional communication according to an embodiment of the present invention.

### DESCRIPTION OF SPECIFIC EMBODIMENTS

Hereinafter, a wireless communication system and a wireless communication method using directional communication according to an embodiment of the present invention will be described in detail with reference to accompanying drawings. In the drawings, line thicknesses or sizes of elements may be exaggerated for clarity and convenience. Also, the following terms are defined considering function of the present invention, and may be differently defined according to intention of an operator or custom. Therefore, the terms should be defined based on overall contents of the specification.

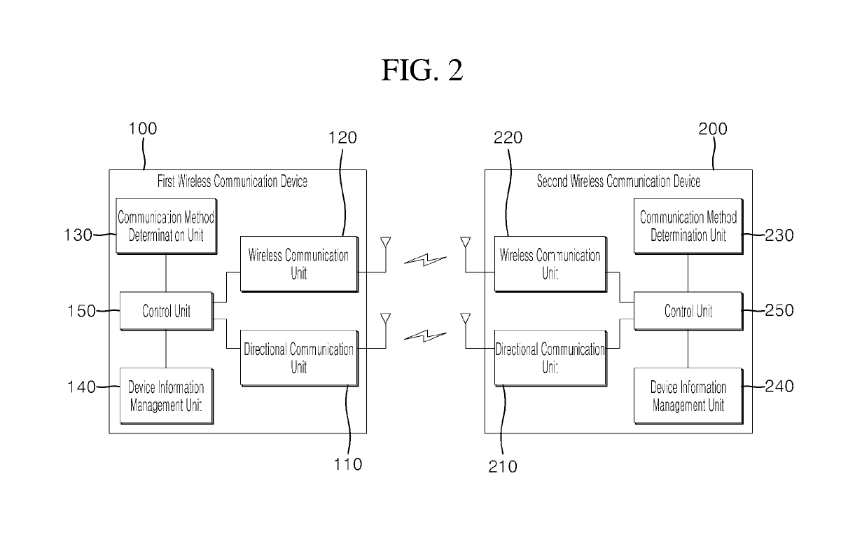

FIG. 2 illustrates a block diagram of a wireless communication system using directional communication according to an embodiment of the present invention.

As illustrated in FIG. 2, a wireless communication system using directional communication according to an embodiment of the present invention includes a first wireless communication device 100 and a second wireless communication device 200, and each of the first wireless communication device 100 and the second wireless communication device 200 includes a directional communication unit 110 or 210, a wireless communication unit 120 or 220, a communication method determination unit 130 or 230, a device information management unit 140 or 240, and a control unit 150 or 250.

The directional communication unit 110 or 210 transmits and receives wireless communication connection information such as a communication identifier through directional beams such as infrared rays and laser beams.

In the case of using infrared rays, the directional communication unit 110 or 210 may transmit and receive the wireless communication connection information thorough Infrared Data Association (IrDA).

In detail, the directional communication unit 110 or 210 may receive wireless communication connection information from the communication target device or transmit the wireless communication connection information to the communication request device that has requested the communication.

The directional communication unit 110 and 210 may be provided with a directional antenna (not illustrated) for forming beams and perform transmission and reception of the wireless communication connection information through directional radio waves.

Here, the wireless communication connection information means information required for wireless communication connection. The wireless communication connection information may include communication identifiers of the first wireless communication device 100 and the second wireless communication device 200, wireless communication technologies supported by the respective communication devices, and service information provided by the respective communication devices.

In this case, the communication identifier means an identifier for identifying a specified wireless communication device, and services provided by the wireless communication device may include various types of services that can be provided using the wireless communication such as data transmission and reception services.

That is, the communication request device requesting the communication of the wireless communication device 100 and the second communication device 200 can acquire the wireless communication connection information such as the communication identifier of the communication target device through the directional communication units 110 and 210.

The communication method determination unit 130 or 230 determines the wireless communication technology based on the wireless communication connection information of the communication target device that is received through the directional communication unit 110 or 210.

Here, the wireless communication technologies may include various wireless communication standards that can wirelessly transmit and receive data, such as Wi-Fi, Wi-Fi P2P(Wi-Fi Direct), Bluetooth, and Zigbee.

The wireless communication unit 120 or 220 performs communication through radio waves, and performs transmission and reception of information that is to be actually transmitted and received according to the wireless communication technology determined by the communication method determination unit 130 or 230.

For example, the wireless communication unit 120 or 220 may transmit and receive the information through Wi-Fi, Wi-Fi P2P (Wi-Fi Direct), Bluetooth or Zigbee.

The device information management unit 140 and 240 store the wireless communication connection information of the first wireless communication device 100 and the second wireless communication device 200.

The control unit 150 or 250 acquires the wireless communication connection information such as the communication identifier of the communication target device through the directional communication unit 110 and 210, and performs the wireless communication connection with the communication target device through control of the wireless communication unit 120 or 220 based on the acquired wireless communication connection information.

In detail, in the case of requesting communication to the communication target device, the control unit 150 or 250 can determine the wireless communication technology through the communication method determination unit 130 or 230 according to the wireless communication connection information received from the communication target device and perform the wireless communication connection with the communication target device.

On the other hand, in the case of requesting communication from the communication request device, the control unit 150 or 250 can transmit the wireless communication connection information stored in the device information management unit 140 or 240 to the communication request device and perform the wireless communication connection with the communication request device.

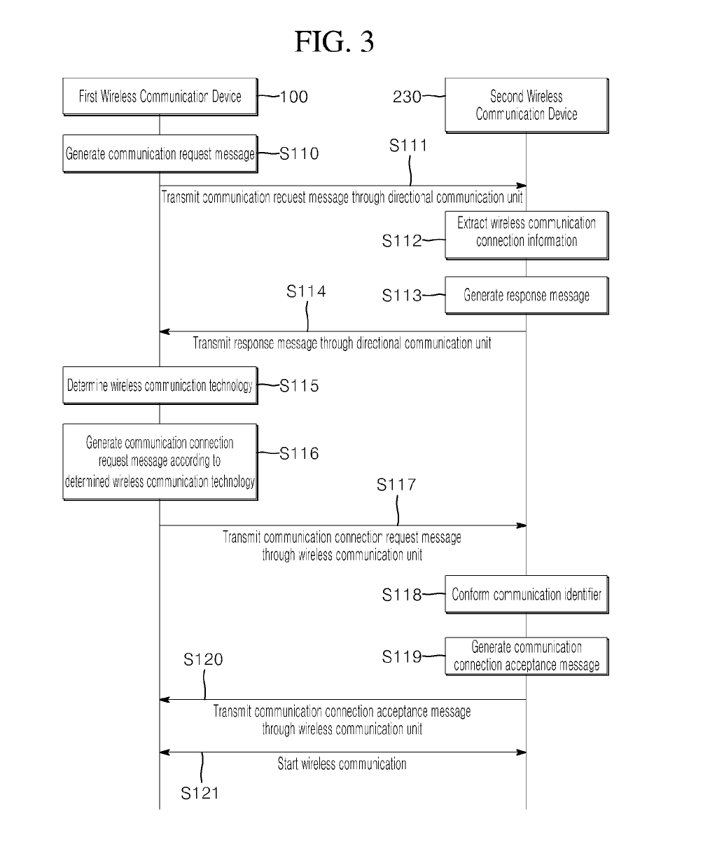

FIG. 3 illustrates an operational flow of a wireless communication method using directional communication according to an embodiment of the present invention. The detailed operation of the present invention will be described with reference to FIG. 3.

For convenience in explanation, it is assumed that the first wireless communication device 100 is a communication request device and the second wireless communication device 200 is a communication target device. However, even in the opposite case, the same operation can be applied.

First, the control unit 150 of the first wireless communication device 100 generates a communication request message according to a user's input signal (S110).

Thereafter, the control unit 150 of the first wireless communication device 100 transmits the communication request message to the directional communication unit 210 of the second wireless communication device 200 through the directional communication unit 110 (S111).

In this case, the directional communication unit 110 may transmit the communication request message thorough Infrared Data Association (IrDA).

If the communication request message is received from the first wireless communication device 100, the control unit 250 of the second wireless communication device 200 extracts the wireless communication connection information from the device information management unit 240 (S112).

Here, the wireless communication connection information may include the communication identifier of the second wireless communication device 200, the wireless communication technology supported by the second wireless communication device 200, and the provided service information.

The control unit 250 of the second wireless communication device 200 generates a response message that includes the extracted wireless communication connection information (S113), and transmits the generated response message to the directional communication unit 110 of the first wireless communication device 100 through the directional communication unit 210 (S114).

In this case, the directional communication unit 210 may transmit the response message thorough Infrared Data Association (IrDA).

Accordingly, the first wireless communication device 100 can acquire the wireless communication connection information such as the communication identifier of the second wireless communication device 200 through the directional communication unit 110.

If the response message that includes the wireless communication connection information is received from the second wireless communication device 200, the control unit 150 of the wireless communication device 100 determines the wireless communication technology through the communication method determination unit 130 (S115).

At this time, the communication method determination unit 130 of the first wireless communication device 100 can determine the wireless communication technology based on the wireless communication connection information included in the response message.

In detail, the communication method determination unit 130 can determine the wireless communication technology by the predefined rule through comparison of the wireless communication technologies supported by the second wireless communication device 200 with the wireless communication technologies provided by the first wireless communication device 100.

However, unlike this, the communication method determination unit 130 may determine the wireless communication technology through reception of an input from the user.

If the wireless communication technology is determined by the communication method determination unit 130, the control unit 150 of the first wireless communication device 100 generates a communication connection request message according to the corresponding wireless communication technology (S116).

At this time, the communication connection request message that is generated by the control unit 150 may include the communication identifier of the second wireless communication device 200.

Thereafter, the control unit 150 of the first wireless communication device 100 transmits the generated communication connection request message to the wireless communication unit 220 of the second wireless communication device 200 through the wireless communication unit 120 (S117).

In this case, the wireless communication unit 120 may transmit the communication connection request message thorough Wi-Fi, Wi-Fi P2P(Wi-Fi Direct) or Bluetooth.

Then, the control unit 250 of the second wireless communication device 200 confirms the communication identifier included in the received communication connection request message (S118), generates a communication connection acceptance message (S119), and transmits the generated communication connection acceptance message to the wireless communication unit 120 of the first wireless communication device 100 through the wireless communication unit 220 (S120).

In this case, the wireless communication unit 220 may transmit the communication connection acceptance message thorough Wi-Fi, Wi-Fi P2P(Wi-Fi Direct) or Bluetooth.

Thereafter, the first wireless communication device 100 and the second wireless communication device 200 start the wireless communication according to the determined wireless communication technology such as Wi-Fi, Wi-Fi P2P(Wi-Fi Direct) or Bluetooth (S121).

Through the above-described process, the user can easily connect to a desired communication target device by pointing at the communication target device as using a remote controller.

That is, the user can easily acquire the wireless communication connection information of the communication target device even in an environment where a large number of devices coexist by the operation of emitting directional beams or directional radio waves to the communication target device through adjustment of the angle and the direction of the directional communication unit 110.

Further, since the communication target device can be selected using the directional communication, the search range can be reduced in comparison to the case where the surrounding devices are searched for in an omnidirectional range of 360 degrees from the viewpoint of device filtering.

The embodiment of the present invention has been disclosed above for illustrative purposes. Those skilled in the art will appreciate that various modifications, additions and substitutions are possible, without departing from the scope and spirit of the invention as disclosed in the accompanying claims.

What is claimed is:

1. A wireless communication system using directional communication comprising:
a communication request device determining a wireless communication technology based on wireless communication connection information acquired through a directional communication medium and performing wireless communication connection; and
a communication target device providing the wireless communication connection information to the communication request device through the directional communication medium.

2. The wireless communication system of claim 1, wherein the wireless communication connection information includes at least one of a communication identifier of the communication target device, wireless communication technologies that are supported by the communication target device, and service information that is provided by the communication target device.

3. The wireless communication system of claim 1, wherein the communication request device comprises:
a directional communication unit transmitting a communication request message to the communication target device through the directional communication medium and receiving the wireless communication connection information from the communication target device through the directional communication medium;
a communication method determination unit determining the wireless communication technology based on the wireless communication connection information; and
a control unit controlling a wireless communication unit according to the determined wireless communication technology and performing the wireless communication connection with the communication target device.

4. The wireless communication system of claim 3, wherein the communication method determination unit determines the wireless communication technology according to a predefined rule through comparison of the wireless communication technologies that are provided by the communication request device with the wireless communication technologies that are supported by the communication target device.

5. The wireless communication system of claim 3, wherein the communication method determination unit determines the wireless communication technology according to an input from a user.

6. The wireless communication system of claim 1, wherein the communication target device comprises:
a device information management unit storing the wireless communication connection information; and
a directional communication unit receiving a communication request message from the communication request device through the directional communication medium and transmitting the wireless communication connection information to the communication request device through the directional communication medium.

7. The wireless communication system of claim 1, wherein the directional communication medium is directional beams or directional radio waves.

8. A wireless communication method using directional communication comprising:
acquiring, by a communication request device, wireless communication connection information of a communication target device through a directional communication medium;
determining, by the communication request device, a wireless communication technology based on the wireless communication connection information; and
performing, by the communication request device, wireless communication connection with the communication target device according to the determined wireless communication technology.

9. The wireless communication method of claim 8, wherein the wireless communication connection information includes at least one of a communication identifier of the communication target device, wireless communication technologies that are supported by the communication target device, and service information that is provided by the communication target device.

10. The wireless communication method of claim 8, wherein the acquiring the wireless communication connection information comprises:
transmitting, by the communication request device, a communication request message to the communication target device through the directional communication medium; and
receiving, by the communication request device, a response message which includes the wireless communication connection information of the communication target device that is generated in response to the communication request message from the communication target device through the directional communication medium.

11. The wireless communication method of claim 10, further comprising:
extracting, by the communication target device, the wireless communication connection information of the communication target device if the communication request message is received; and
transmitting, by the communication target device, the response message that includes the wireless communication connection information to the communication request device through the directional communication medium. 5

12. The wireless communication method of claim 8, wherein in the determining the wireless communication technology, the communication request device determines the wireless communication technology according to a predefined rule through comparison of the wireless communication technologies that are provided by the communication request device with the wireless communication technologies that are supported by the communication target device.

13. The wireless communication method of claim 8, wherein in the determining the wireless communication technology, the wireless communication technology is determined according to an input from a user.

14. The wireless communication method of claim 8, wherein the directional communication medium is directional beams or directional radio waves.
